(19) United States
(12) Patent Application Publication
(10) Pub. No.: US 2003/0071578 A1
(43) Pub. Date: Apr. 17, 2003

(54) Apparatus and method for driving plasma display panel

(75) Inventors: Jun-Young Lee, Cheonan-City (KR); Jung-Pil Park, Cheonan-City (KR); Byung-Nam An, Busan-City (KR)

Correspondence Address: McGuire Woods, Suite 1800, 1750 Tysons Boulevard, McLean, VA, 22102-4215, US

(73) Assignee: Samsung SDI Co., Ltd.

(21) Appl. No.: 10/270,668

(22) Filed: Oct. 16, 2002

(30) Foreign Application Priority Data
Oct. 16, 2001 (KR) 2001-63803
Feb. 18, 2002 (KR) 2002-8405

(51) Int. Cl. G09G 3/10

(52) U.S. Cl. 315/169.3

(57) ABSTRACT

Disclosed is an apparatus and method for driving a plasma display panel (PDP) where a switch device can perform zero voltage switching in driving the PDP. The apparatus for driving the PDP includes a sustain-discharge unit including first through fourth switches respectively connected to both ends of a panel capacitor between a power source and ground, for sustaining a panel capacitor terminal voltage to be at a first or a second sustain-discharge voltage; a first charge and discharge unit including a first inductor, for increasing the voltage of the panel capacitor to the first sustain-discharge voltage and switching a first switch in a state of a zero voltage by half of a resonance current generated by the first inductor; and a second charge and discharge unit including a second inductor, for decreasing the voltage of the panel capacitor to the second sustain-discharge voltage and switching a third switch in a state of the zero voltage by half of a resonance current generated by the second inductor.

### BACKGROUND OF THE INVENTION

1. Field of the Invention

The present invention relates to an apparatus and a method for driving a plasma display panel (PDP). More specifically, the present invention relates to an apparatus and a method for driving a PDP, where a switch device can perform zero voltage switching in driving the PDP.

2. Description of the Related Art

In general, a PDP is a flat plate display for displaying characters or images using plasma generated by gas discharge. Pixels ranging from hundreds of thousands to more than millions are arranged in the form of a matrix according to the size of the PDP. PDPs are divided into direct current (DC) PDPs and alternating current (AC) PDPs according to the shape of the waveform of an applied driving voltage and the structure of a discharge cell.

The most significant difference between the DC PDP and the AC PDP lies in that current directly flows in discharge spaces while a voltage is applied in the DC PDP, because electrodes are exposed to the discharge spaces. Therefore, a resistor for restricting the current must be used outside of the DC PDP. On the other hand, in the case of the AC PDP, the current is restricted due to the natural formation of capacity because a dielectric layer covers the electrodes. The AC PDP has a longer life than the DC PDP because the electrodes are protected against the shock caused by ions during discharge. A memory characteristic that is one of the important characteristics of the AC PDP is caused by the capacity due to the dielectric layer that covers the electrodes.

According to the light emission principle of the AC PDP, discharge occurs because an electric potential difference in the form of a pulse is formed in common electrodes (X electrodes) and scan electrodes (Y electrodes). As such, vacuum ultraviolet (UV) rays generated in a discharge process are excited to red R, green G, and blue B fluorescent bodies. The respective fluorescent bodies emit light due to light combination.

In the AC PDP, because the X electrodes and the Y electrodes for sustaining discharge operate as capacitive loads, capacitance Cₚ with respect to the X and Y electrodes exists. Reactive power other than power for discharge is necessary in order to apply waveforms for the sustain-discharge. A circuit for recovering and re-using the reactive power is referred to as a sustain-discharge circuit, or a power recovery circuit.

According to the method for driving the panel by the X and Y electrode driving circuits, a frame consists of n sub-fields. A sub-field consists of a reset period, a scan period, a sustain period, and an erase period.

In the reset period, the address electrodes A₁ through Aₘ and the X electrodes are sustained to be at 0 V in the first half thereof. A voltage of more than a discharge starting voltage to a voltage of no more than the discharge starting voltage with respect to the sustain electrodes is applied to the Y electrodes. In the latter half of the reset period, the voltage of no more than the discharge starting voltage with respect to the sustain electrodes is applied to the scan electrodes. In the scan period, the scan electrodes are sustained to be at a scan voltage. A positive scan pulse voltage and a scan pulse voltage (0 V) are simultaneously applied to the address electrode corresponding to the discharge cell to be displayed in the first line among addressing electrodes and the scan electrode in the first line, respectively, so that the wall charge is accumulated. In the sustain period, a predetermined sustain pulse is applied to the scan and sustain electrodes so that the sustain-discharge occurs in gray scales to be displayed in the discharge cells. In the erase period, a predetermined erase pulse is applied to the sustain electrodes so that the sustain-discharge is stopped.

Driving of the sustain-discharge circuit of a conventional AC PDP will now be described with reference to FIGS. 1A and 1B that show a conventional sustain-discharge circuit and the operation waveforms of the conventional sustain-discharge circuit.

As shown in FIG. 1A, the sustain-discharge circuit suggested by L. F. Weber and disclosed in the U.S. Pat. Nos. 4,866,349 and 5,081,400, is the sustain-discharge circuit or the power recovery circuit of the AC PDP. In the driving circuit of the AC PDP, a sustain-discharge circuit 10 of the X electrodes has the same structure as that of a sustain-discharge circuit 11 (not shown in detail) of the Y electrodes. The sustain-discharge circuit of the X electrodes will now be described for sake of convenience.

The conventional sustain-discharge circuit 10 includes a power recovery unit comprising two switches S₁ and S₂, two diodes D₁ and D₂, and a power recovery capacitor C_{c} and a sustain-discharge unit comprising two serially connected switches S₃ and S₄. An inductor L_{c} is connected between the diodes D₁ and D₂ of the power recovery unit and the two switches S₃ and S₄ of the sustain-discharge unit. A load having a capacitor Cₚ of the PDP is connected to the sustain-discharge unit. At this juncture, a parasitic device is not displayed.

The conventional sustain-discharge circuit having the above structure operates in four modes according to the switching sequence operations of the switches S₁ through S₄, as shown in FIG. 1B. The waveforms of the current I_{L} that flows through an output voltage Vₚ and the inductor L_{c} are respectively shown according to the switching sequence operations.

In an initial stage, the panel both-end voltage is sustained to be 0 V because the switch S₄ is made to turn on just before the switch S₁ is made to turn on. As such, the power recovery capacitor C_{c} is previously charged by a voltage Vₛ/2 that is half of an external applied voltage Vₛ so that a rush current is not generated when the sustain-discharge starts.

In a state where the panel both-end voltage Vₚ is sustained to be 0 V, at the point of time t₀, the operation of a mode 1 where the switch S₁ is turned on and the switches S₂, S₃, and S₄ are turned off, starts.

In the operation periods between t₀ and t₁ of the mode 1, an LC resonance circuit is formed through the channel of the power recovery capacitor C_{c}, the switch S₁, the diode D₁, the inductor L_{c}, and the plasma panel capacitor Cₚ. Therefore, the current I_{L} flows through the inductor L_{c} and the output voltage Vₚ of the panel increases.

As shown in FIG. 1B, the current I_{L} that flows through the inductor L_{C} slowly decreases due to parasitic resistance (not shown) and becomes 0 at the point of time t₁. The output voltage Vₚ of the panel becomes the external applied voltage Vₛ.

When the mode 1 is completed, a mode 2, where the switches S₁ and S₃ are turned on and the switches S₂ and S₄ are turned off, starts. In the operation period between t₁ and t₂ of the mode 2, the external applied voltage Vₛ directly flows through the panel capacitor Cₚ through the switch S₃, to thus sustain the output voltage Vₚ of the panel.

When the mode 2 is completed in a state where the discharge of the output voltage Vₚ of the panel is sustained, a mode 3, where the switch S₂ is turned on and the switches S₁, S₃, and S₄ are turned off, starts.

In the operation period between t₂ and t₃ of the mode 3, the LC resonance circuit is formed through the channel reverse to that in the mode 1, that is, through the channel of the plasma panel capacitor Cₚ, the inductor L_{c}, the diode D₁, the switch S₂, and the power recovery capacitor C_{c}. Accordingly, as shown in FIG. 1B, the current I_{L} flows through the inductor L_{c} and the output voltage Vₚ of the panel decreases. Therefore, the current I_{L} of the inductor L_{c} and the output voltage Vₚ of the panel become 0 at the point of time t₃.

In the operation period between t₃ and t₄ of a mode 4, the switches S₂ and S₄ are turned on and the switches S₁ and S₃ are turned off. Accordingly, the output voltage Vₚ of the panel is sustained to be 0 V. When the switch S₁ is turned on again in this state, the process returns to the operation of the mode 1. Accordingly, the operations are repeated thereinafter.

In the conventional sustain-discharge circuit 10, because the number of the switches of the power recovery unit of the entire sustain-discharge circuit (including the X and Y electrode driving circuits) is four, the structure of an operation driver is complicated. Because a high-priced switch device is used, it is difficult to realize a low-priced sustain-discharge driving circuit.

In addition, it is not possible for the switches that form the circuit to perform the zero voltage switching due to the parasitic components of the driving circuit such as the parasitic resistance of the inductor, the parasitic resistances of the capacitor and the panel, and the conductance resistance of the switch. Accordingly, switching loss significantly increases when the switches are turned on.

Also, a significantly large rush current is generated when a sustain pulse starts in a state where the power recovery capacitor C_{c} is not charged to the voltage Vₛ/2 right after the light emission starts.

### SUMMARY OF THE INVENTION

It is an object of the present invention to provide a sustain-discharge circuit of a PDP, wherein a sustain-discharge circuit can be operated by a switch, an operation switch that forms the sustain-discharge circuit can perform zero voltage switching, and a rush current can be prevented without an additional external protecting circuit just after light emission starts.

In order to achieve the above object, in an embodiment of the present invention, there is provided an apparatus and a method for driving a PDP including a plurality of address electrodes, a plurality of scan electrodes and sustain electrodes arranged in a zig-zag pattern so as to make pairs with each other, and a panel capacitor formed by the scan electrodes and the sustain electrodes.

In one aspect of an embodiment of the present invention, there is provided an apparatus for driving a PDP including a sustain-discharge unit and first and second charge and discharge units. The sustain-discharge unit includes first and second switches, which are serially connected to each other between a power source to which a sustain-discharge voltage is applied and a ground, and whose contact point is connected to one end of the panel capacitor; and third and fourth switches, which are serially connected to each other between the power source and the ground and whose contact point is connected to the other end of the panel capacitor. The first charge and discharge unit includes a first inductor whose one end is coupled to one end of the panel capacitor, and which increases the voltage of the panel capacitor to the first sustain-discharge voltage using a resonance of the first inductor and the panel capacitor. The second charge and discharge unit includes a second inductor whose one end is coupled to the other end of the panel capacitor, and which decreases the voltage of the panel capacitor to the second sustain-discharge voltage using a resonance of the second inductor and the panel capacitor.

At this time, the sustain-discharge unit drives the first switch during resonance of the first inductor, to thus sustain the first sustain-discharge voltage, and drives the third switch during resonance of the second inductor, to thus sustain the second sustain-discharge voltage.

In a second aspect of an embodiment of the present invention, there is provided an apparatus for driving a PDP including first through sixth switches, first and second inductors, and first and second diodes. The first and second switches are serially connected to each other between a power source to which a sustain-discharge voltage is applied and a ground and a contact point thereof is connected to one end of the panel capacitor. The third and fourth switches are serially connected to each other between the power source and the ground, and a contact point thereof is connected to the other end of the panel capacitor. The first inductor has one end coupled to one end of the panel capacitor, and the second inductor has one end coupled to the other end of the panel capacitor. The fifth and sixth switches are respectively connected between the power source and the other end of the first inductor, and between the power source and the other end of the second inductor. The first and second diodes are respectively connected between the other end of the first inductor and the ground, and between the other end of the second inductor and the ground.

In a third aspect of an embodiment of the present invention, there is provided an apparatus for driving a PDP including first through eighth switches, first and second inductors, and first through fourth diodes. The first and second switches are serially connected to each other between a power source to which a sustain-discharge voltage is applied and a ground, and a contact point thereof is connected to one end of the panel capacitor. The third and fourth switches are serially connected to each other between the power source and the ground, and a contact point thereof is connected to the other end of the panel capacitor. The first inductor has one end coupled to one end of the panel capacitor, and the second inductor has one end coupled to the other end of the panel capacitor. The fifth and sixth switches are serially connected to each other between the power source and the ground, and a contact point thereof is connected to the other end of the first inductor. The seventh and eighth switches are serially coupled to each other between the power source and the ground, and a contact point thereof is connected to the other end of the second inductor. The first and second diodes are serially connected to each other between the power source and the ground in a backward direction, and a contact point thereof is connected to the other end of the first inductor. The third and fourth diodes are serially connected to each other between the power source and the ground in a backward direction, and a contact point thereof is connected to the other end of the second inductor.

In fourth through seventh aspects of an embodiment of the present invention, there is provided a method for driving a PDP including a plurality of address electrodes, a plurality of scan electrodes and sustain electrodes arranged in a zig-zag pattern so as to make pairs with each other, a panel capacitor formed by the scan electrodes and the sustain electrodes, first and second switches, which are serially connected to each other between a power source for supplying a sustain-discharge voltage and a ground, and whose contact point is connected to one end of the panel capacitor, third and fourth switches, which are serially connected to each other between the power source and the ground and whose contact point is connected to the other end of the panel capacitor, and first and second inductors connected to one end and to the other end of the panel capacitor.

In a fourth aspect of an embodiment of the present invention, according to a method for driving a PDP, the voltage of the panel capacitor increases to a first sustain-discharge voltage using a resonance generated by the panel capacitor and the first inductor due to the driving of the fourth switch and a fifth switch connected between the power source and the first inductor. The first and fourth switches are driven during the resonance to thus sustain the voltage of the panel capacitor to be at the first sustain-discharge voltage. The voltage of the panel capacitor decreases to a second sustain-discharge voltage using resonance generated by the panel capacitor and the second inductor due to the driving of the second switch and a sixth switch connected between the power source and the second inductor. The second and third switches are driven during the resonance to thus sustain the voltage of the panel capacitor to be at the second sustain-discharge voltage.

In a fifth aspect of an embodiment of the present invention, according to a method for driving a PDP, the voltage of the panel capacitor increases to a first sustain-discharge voltage using a resonance generated by the panel capacitor and the first and second inductors due to the driving of a fifth switch connected between the power source and the first inductor, and a sixth switch connected between the second inductor and the ground. The fifth and sixth switches are turned off during the resonance and driving of the first and fourth switches to thus sustain the voltage of the panel capacitor to be at the first sustain-discharge voltage. The voltage of the panel capacitor decreases to a second sustain-discharge voltage using a resonance generated by the panel capacitor and the first and second inductors due to the driving of a seventh switch connected between the power and the second inductor, and an eighth switch connected between the first inductor and the ground. The seventh and eighth switches are turned off during the resonance and driving of the second and third switches to thus sustain the voltage of the panel capacitor to be at the second sustain-discharge voltage.

In a sixth aspect of an embodiment of the present invention, according to a method for driving a PDP, first and fourth switches are driven to thus sustain the voltage of the panel capacitor to be at a first sustain-discharge voltage. Fifth and sixth switches, respectively connected between the ground and the first inductor and between the second inductor and the power source, are additionally driven to thus inject current into the first and second inductors in a state where the voltage of the panel capacitor is sustained to be at the first sustain-discharge voltage. The first, fourth, fifth, and sixth switches are turned off to thus decrease the voltage of the panel capacitor to a second sustain-discharge voltage using resonance generated by the first and second inductors and the panel capacitor. The second and third switches are driven to thus sustain the voltage of the panel capacitor to be at the second sustain-discharge voltage. Seventh and eighth switches, respectively connected between the power source and the first inductor and between the second inductor and the ground, are additionally driven to thus inject current into the first and second inductors in a state where the voltage of the panel capacitor is sustained to be at the second sustain-discharge voltage. The second, third, seventh, and eighth switches are turned off to thus increase the voltage of the panel capacitor to a first sustain-discharge voltage using resonance generated by the first and second inductors and the panel capacitor.

In a seventh aspect of an embodiment of the present invention, according to a method for driving a PDP, fifth and sixth switches, respectively connected between the power source and the first inductor and between the second inductor and the ground are driven to thus inject current into the first and second inductors in a state where the voltage of the panel capacitor is sustained to be at a first sustain-discharge voltage by the driven second and third switches. The second and third switches are turned off to thus increase the voltage of the panel capacitor to a second sustain-discharge voltage using resonance generated by the first and second inductors and the panel capacitor. The fifth and sixth switches are turned off and the first and fourth switches are driven to thus sustain the voltage of the panel capacitor to be at the second sustain-discharge voltage. Seventh and eighth switches, respectively connected between the first inductor and the ground and between the power source and the second inductor, are additionally driven to thus inject current into the first and second inductors in a state where the voltage of the panel capacitor is sustained to be at the second sustain-discharge voltage. The first and fourth switches are turned off, to thus decrease the panel capacitor to the first sustain-discharge voltage using resonance generated by the first and second inductors and the panel capacitor. The seventh and eighth switches are turned off and the second and third switches are driven to thus sustain the voltage of the panel capacitor to be at the first sustain-discharge voltage.

### BRIEF DESCRIPTION OF THE DRAWINGS

The accompanying drawings, which are incorporated in and constitute a part of the specification, illustrate an embodiment of the invention, and, together with the description, serve to explain the principles of the invention, in which:

FIGS. 1A and 1B show a conventional sustain-discharge circuit and the operation waveforms of the conventional sustain-discharge circuit;

FIG. 2 is a circuit diagram showing a sustain-discharge circuit according to a first embodiment of the present invention;

FIG. 3 shows the operation waveforms of the sustain-discharge circuit according to the first embodiment of the present invention;

FIG. 4 is a circuit diagram showing a sustain-discharge circuit according to a second embodiment of the present invention;

FIG. 5 shows the operation waveforms of the sustain-discharge circuit according to the second embodiment of the present invention;

FIG. 6 shows the operation waveforms of a sustain-discharge circuit according to a third embodiment of the present invention; and

FIG. 7 shows the operation waveforms of a sustain-discharge circuit according to a fourth embodiment of the present invention.

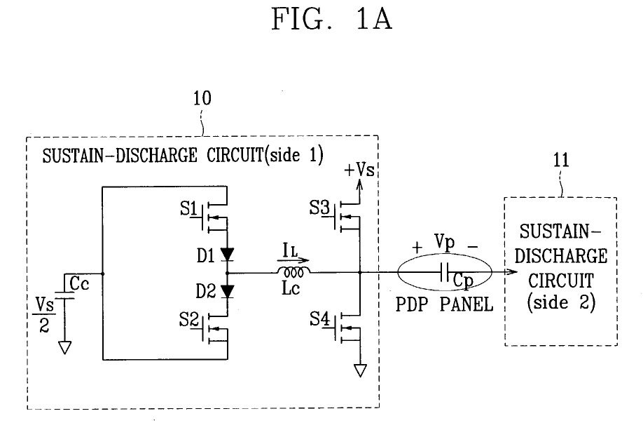

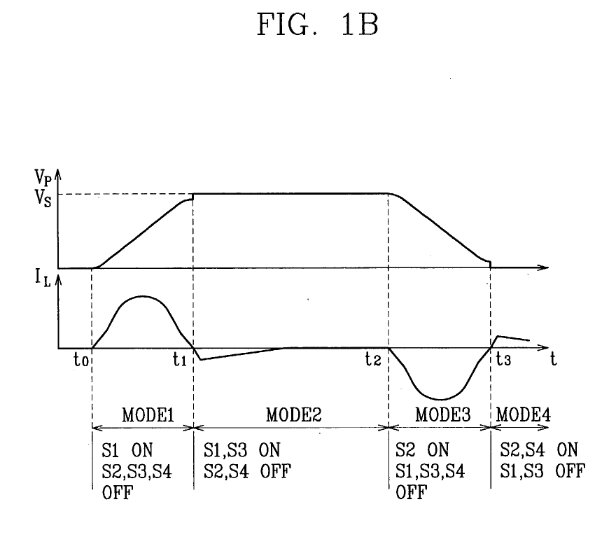

### DETAILED DESCRIPTION OF THE PREFERRED EMBODIMENTS

In the following detailed description, only a preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

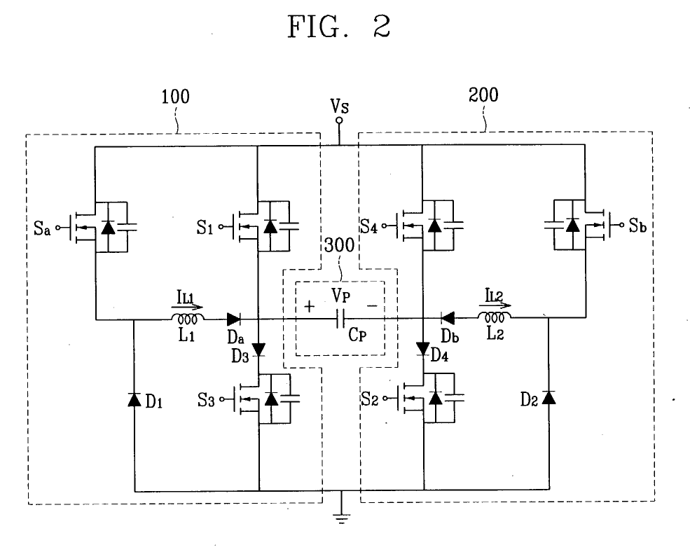

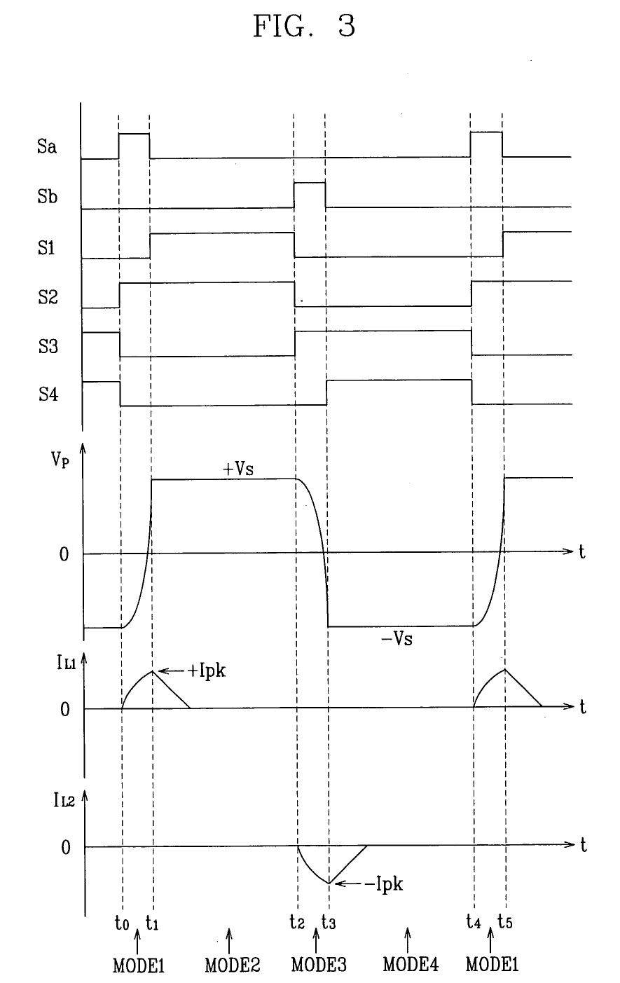

A sustain-discharge circuit according to a first embodiment of the present invention will now be described in detail with reference to FIGS. 2 and 3.

FIG. 2 is a circuit diagram showing a sustain-discharge circuit according to a first embodiment of the present invention. FIG. 3 shows the operation waveforms of the sustain-discharge circuit according to the first embodiment of the present invention.

As shown in FIG. 2, the sustain-discharge circuit according to the first embodiment of the present invention includes a Y electrode driving unit 100 for sustain-discharging the Y electrode by the control pulse operation of a switch Sₐ, an X electrode driving unit 200 for sustain-discharging the X electrode by the control pulse operation of a switch S_{b}, and a panel 300 for displaying desired gray scales by sustain-discharging the wall charge accumulated in the respective X and Y electrodes according to the driving signal of the X and Y electrode driving units 200 and 100, respectively.

The Y electrode driving unit 100 includes three switches Sₐ, S₁, and S₃, three diodes Dₐ, D₁, and D₃, and an inductor L₁. Each switch is a MOSFET, and each further includes a body diode and an internal capacitor according to the characteristics of the MOSFET.

The X electrode driver 200 is symmetrical to the Y electrode driving unit 100 on the basis of the panel 300, and includes three switches S_{b}, S₂, and S₄, three diodes D_{b}, D₂, and D₄, and an inductor L₂.

As shown in FIG. 3, the operations of the sustain-discharge circuit according to the first embodiment of the present invention are divided into a mode 1 period t₀ through t₁ for charging the capacitor Cₚ of the panel 300, a mode 2 period t₁ through t₂ for sustaining the capacitor Cₚ to be at a high level voltage +Vₛ for sustain-discharge, a mode 3 period t₂ through t₃ for discharging the capacitor Cₚ of the panel, and a mode 4 period t₃ through t₄ for sustaining the capacitor Cₚ to be at a low level voltage −Vₛ for sustain-discharge. In order to describe an initial state, it is assumed that the current I_{L} of the inductor is 0 in the initial mode 1 (section t₀ through t₁,) and that a panel both-end voltage is the voltage −Vₛ.

When the switch Sₐ and the switch S₂ are turned on in the mode 1 period, a resonance circuit is formed through a path of the switch Sₐ—the inductor L₁—the diode Dₐ—the panel capacitor Cₚ—the diode D₄—the switch S₂. Current I_{L1} that flows through the inductor L₁ from an external applied voltage Vₛ is resonance current caused by the inductor L₁ and the panel capacitor Cₚ. The panel both-end voltage Vₚ increases to the voltage +Vₛ by the resonance current. The panel both-end voltage Vₚ becomes the voltage +Vₛ and the inductor current I_{L1} increases to current Iₚₖ at a time t₁.

In the mode 2 period t₁ through t₂, when the switch S₁ is turned on at the time t₁, the panel both-end voltage Vₚ is sustained to be at the external applied voltage +Vₛ and the body diode of the switch S₁ and the diode D₁ conduct. The inductor current I_{L1} increased to the current Iₚₖ during the mode 1 period flows toward power Vₛ through the current path of the diode D₁—the inductor L₁—the diode Dₐ—the body diode of the switch S₁ since the switch Sₐ is turned off. Accordingly, energy is recovered toward the power Vₛ.

Accordingly, the inductor current I_{L1} linearly decreases to 0. The mode 2 period is completed when the switch S₁ and the switch S₂ are turned off at a time t₂. At the point of time where the switch S₁ is turned on, because the switch S₁ is turned on in a state where the drain-source both-end voltage V_{ds} of the switch S₁ is a zero voltage, turn-on switching loss is not generated.

In the mode 3 period t₂ through t₃, when the switches S_{b} and S₃ are turned on at a time t₂, a resonance circuit is formed through a path of the switch S_{b}—the inductor L₂—the diode D_{b}—the panel capacitor Cₚ—the diode D₃—the switch S₃. Resonance current I_{L2} caused by the inductor L₂ and the panel capacitor Cₚ flows through the inductor L₂. The panel both-end voltage decreases to the voltage −Vₛ due to the resonance current. The panel both-end voltage Vₚ becomes the voltage −Vₛ and inductor current I_{L2} decreases to current −Iₚₖ at a time t₃. When the switch S_{b} is turned off at the time t₃, the mode 3 period is completed.

In a mode 4 period t₃ through t₄, when the switch S₄ is turned on at the time t₃, the voltage Vₚ is sustained to be at the voltage −Vₛ and the body diode of the switch S₄ and the diode D₂ conduct. The inductor current I_{L2} that decreases to the current −Iₚₖ during the mode 3 period flows toward the power Vₛ through the current path of the diode D₂—the inductor L₂—the diode D_{b}—the body diode of the switch S₄ since the switch S_{b} is turned off. Energy is recovered toward the power Vₛ.

The inductor current I_{L2} decreases to the current −Iₚₖ and linearly increases to 0 when it is assumed that current flows from the left side to the right side. When the switch S₃ and the switch S₄ are turned off at a time t₄, the mode 4 period is completed and the process returns to the mode 1 period. Accordingly, operation cycles are repeated thereinafter. At the point of time where the switch S₄ is turned on, because voltage difference between both ends of the switch S₄ becomes 0, zero voltage switching can be performed.

According to the sustain-discharge circuit according to the first embodiment of the present invention, because the switches S₁ and S₄ perform the zero voltage switching, switching is performed without turn-on switching loss. However, the operation potential of the X and Y electrode driving units decreases to no more than ground level potential (GND) while energy is recovered.

For example, in a state where the panel both-end voltage Vₚ is sustained to be at the voltage +Vₛ (like in the mode 2), the drain of the switch S₃ is at a voltage +Vₛ level and the drain of the switch S₂ is a ground level. When the switch S_{b} and the switch S₃ are turned on in order to invert the polarity of the panel both-end voltage into the voltage −Vₛ at the time t₂, the drain of the switch S₃ decreases from the voltage +Vₛ to the ground level the moment the switch S₃ is turned on. However, the panel both-end voltage Vₚ is sustained to be at the voltage +Vₛ. Accordingly, the drain of the switch S₂ decreases to the voltage −Vₛ.

In order to compensate for a problem in that the operation potential of the X and Y electrode driving units, 100 and 200, respectively, in the first embodiment of the present invention decreases to no more than the ground level, a sustain-discharge circuit according to a second embodiment of the present invention is provided.

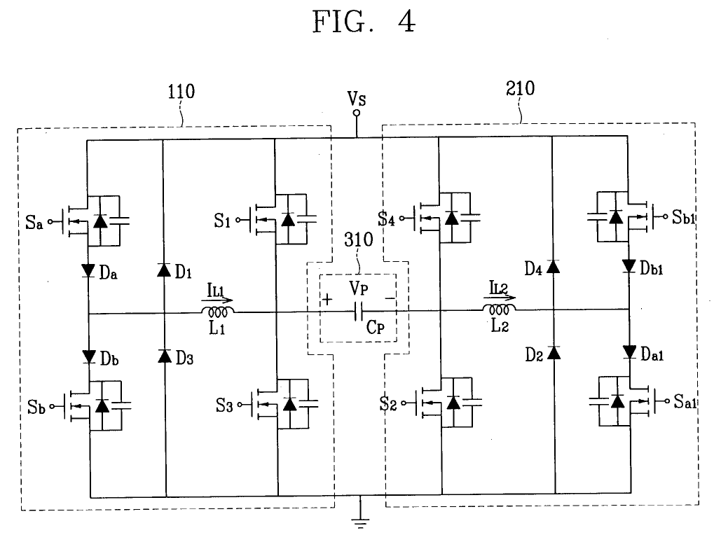

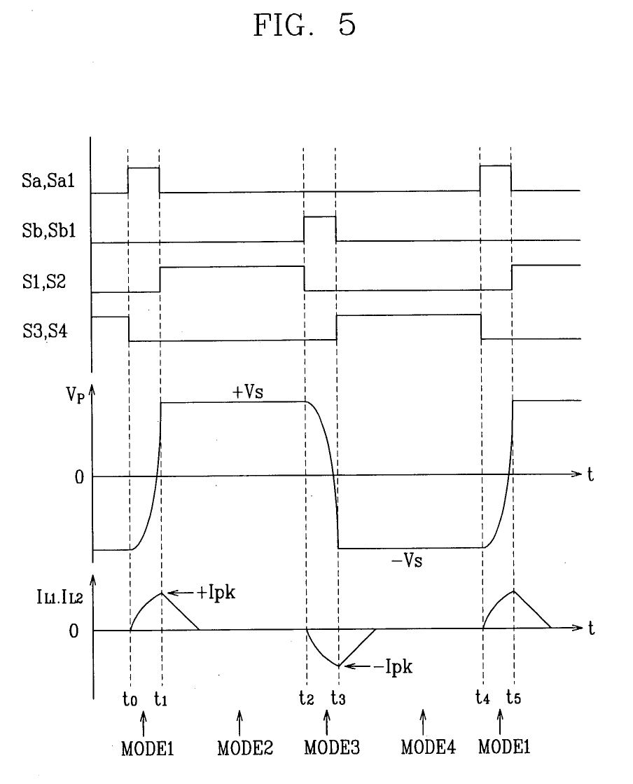

FIG. 4 is a circuit diagram showing a sustain-discharge circuit according to a second embodiment of the present invention. FIG. 5 shows the operation waveforms of the sustain-discharge circuit according to the second embodiment of the present invention.

The sustain-discharge circuit according to the second embodiment of the present invention has the same structure as that of the sustain-discharge circuit according to the first embodiment of the present invention. Description of parts overlapping the first embodiment of the present invention will therefore be omitted.

As shown in FIG. 4, the sustain-discharge circuit according to the second embodiment of the present invention includes a Y electrode driving unit 110 for sustain-discharging the Y electrode by the control pulse operation of the switches Sₐ and S_{b} in the sustain-discharge circuit according to the first embodiment, an X electrode driving unit 210 for sustain-discharging the X electrode by the control pulse operation of switches Sₐ₁ and S_{b1}, and the panel 300 for displaying desired gray scales by performing the sustain-discharge of the wall charge accumulated in the respective X and Y electrodes according to the driving signal of the X and Y electrode driving units 210 and 110.

The Y electrode driving unit 110 includes the four switches Sₐ, S_{b}, S₁, and S₃, the four diodes Dₐ, D_{b}, D₁, and D₃, and the inductor L₁. The X electrode driving unit 210 includes the four switches Sₐ₁, S_{b1}, S₂, and S₄, the four switches Dₐ₁, D_{b1}, D₂, and D₄, and the inductor L₂.

The operation of the sustain-discharge circuit according to the second embodiment of the present invention will now be described in detail with reference to FIG. 5.

When it is assumed that the inductor currents I_{L1} and I_{L2} are 0 and that the panel both-end voltage Vₚ is the voltage −Vₛ, when the switch Sₐ and the switch Sₐ₁ are turned on in the mode 1 period, a resonance path of the switch Sₐ—the diode Dₐ—the inductor L₁—the panel capacitor Cₚ—the inductor L₂—the diode Dₐ₁—the switch Sₐ₁ is formed.

The inductor currents I_{L1} and I_{L2} become resonance current caused by serial connection between the inductor L₁ and the inductor L₂ flows. The panel both-end voltage increases to the voltage +Vₛ according to the resonance current. At the time t₁, the panel both-end voltage Vₚ becomes the voltage +Vₛ and the inductor currents I_{L1} and I_{L2} increase to the current Iₚₖ.

In the mode 2 (period t₁ through t₂), when the switch S₁ and the switch S₂ are turned on at the time t₁, the panel both-end voltage Vₚ is sustained to be at the voltage +Vₛ, and the body diodes of the switch S₁ and the switch S₂ and the diodes D₃ and D₄ conduct. The inductor current I_{L1} that increases to the current Iₚₖ during the mode 1 period flows toward the power through the body diode of the switch S₁ and the diode D₃, and linearly decreases to 0. When the switch S₁ is turned on, because the switch S₁ is turned on in a state where the drain-source both-end voltage V_{ds} is the zero voltage, the turn-on switching loss is not generated.

The current I_{L2} that flows through the inductor L₂ flows toward the power through the body diode of the switch S₂ and the diode D₄, and linearly decreases to 0. At the point of time where the switch S₂ is turned on, the switch S₂ is turned on in a state where the drain-source both-end voltage V_{ds} of the switch S₂ is the zero voltage, like when the switch S₁ is turned on. When the switch S₁ and the switch S₂ are turned off at the time t₂, the mode 2 period is completed.

In the mode 3 period t₂ through t₃, when the switch S_{b} and the switch S_{b1} are turned on at the time t₂, a resonance path of the switch S_{b1}—the diode D_{b1}—the inductor L₂—the panel capacitor Cₚ—the inductor L₁—the diode D_{b}—the switch S_{b} is formed. The inductor currents I_{L1} and I_{L2} become the resonance current caused by the inductors L₁ and L₂ and the panel capacitor Cₚ. The panel both-end voltage decreases to the voltage −Vₛ. At the time t₃, the panel both-end voltage Vₚ becomes the voltage −Vₛ, and the inductor currents I_{L1} and I_{L2} decrease to the current −Iₚₖ. When the switch S_{b} and the switch S_{b1} are turned off, the mode 3 period is completed.

In the mode 4 period t₃ through t₄, when the switch S₃ and the switch S₄ are turned on at the time t₃, the panel both-end voltage Vₚ is sustained to be at the voltage −Vₛ, and the body diodes of the switch S₃ and the switch S₄ and the diodes D₁ and D₂ conduct. The current I_{L1} of the inductor L₁, which decreases to the current −Iₚₖ during the mode 3 period flows toward the power through the body diode of the switch S₃ and the diode D₁, and linearly increases to 0. At the point of time where the switch S₃ is turned on, because the switch S₃ is turned on in a state where the drain-source both-end voltage V_{ds} of the switch S₃ is the zero-voltage, the turn-on switching loss is not generated.

Also, the current I_{L2} that flows through the inductor L₂ flows toward the power through the body diode of the switch S₄ and the diode D₂ and linearly increases to 0. At the point of time where the switch S₄ is turned on, the switch S₄ is turned on in a state where the drain-source both-end voltage V_{ds} of the switch S₄ is the zero-voltage, like when the switch S₃ is turned on.

When the switch S₃ and the switch S₄ are turned off at the time t₄, the mode 4 period is completed and the mode 1 period starts.

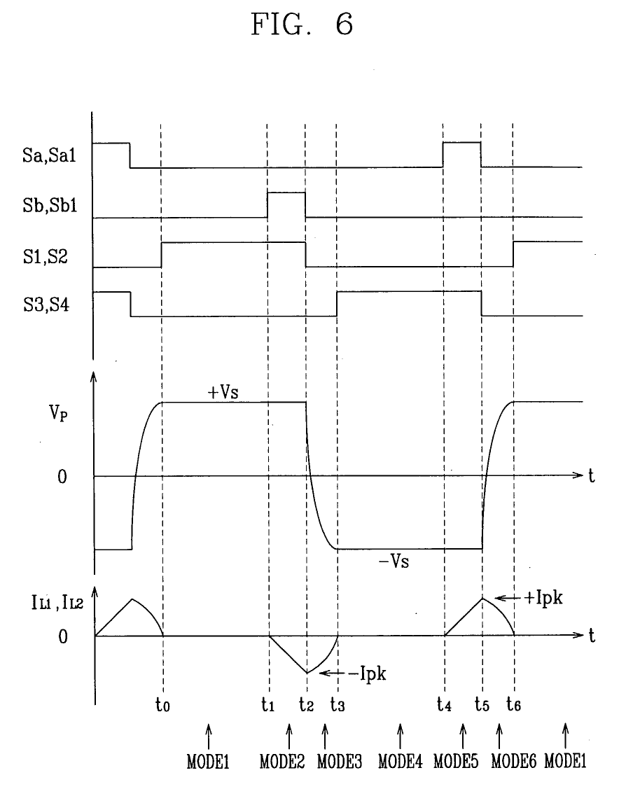

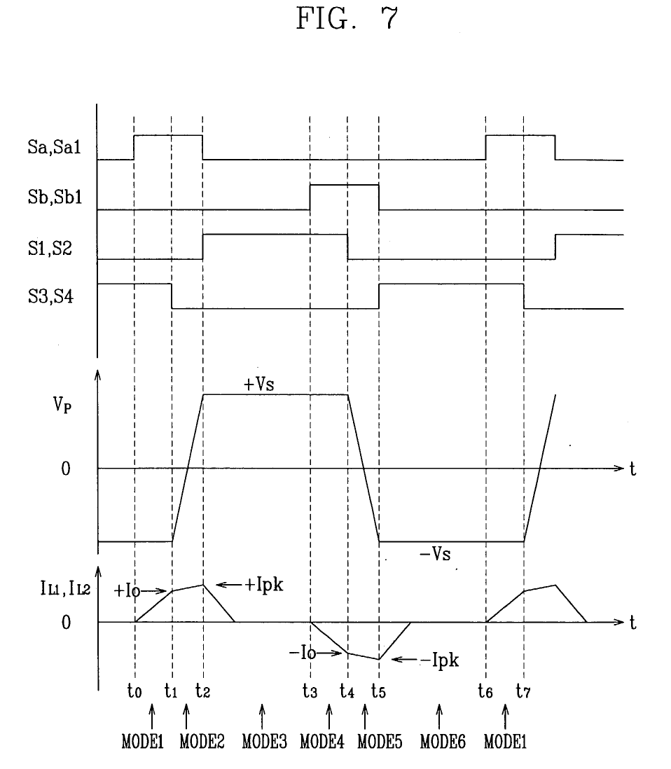

As mentioned above, according to the second embodiment of the present invention, the panel both-end voltage Vₚ is changed using resonance. However, current can be previously injected into the inductor before changing the panel both-end voltage in the sustain-discharge circuit according to the second embodiment. That is, when the panel both-end voltage is sustained to be at the voltages +Vₛ and −Vₛ, it is possible to inject current into the inductor and to change the panel both-end voltage using the current and the resonance. Such an embodiment will now be described with reference to FIGS. 6 and 7.

FIGS. 6 and 7 respectively show the operation waveforms of the sustain-discharge circuits according to the third and fourth embodiments of the present invention.

The only difference between the third and fourth embodiments and the second embodiment is the operation waveforms of the sustain-discharge circuit.

The driving method according to the third embodiment will now be described with reference to FIG. 6. In the mode 1 period t₀ through t₁, the switches S₁ and S₂ are turned on. Accordingly, the panel both-end voltage Vₚ is sustained to be at the voltage +Vₛ.

In the mode 2 period t₁ through t₂, the switches S_{b} and S_{b1} are turned on at the time t₁. A path of the switch S_{b1}—the diode D_{b1}—the inductor L₂—the switch S₂ is formed by the switches S_{2 and S}_{b1} that are turned on. Accordingly, the current I_{L2} that flows through the inductor L₂ linearly decreases to the current −Iₚₖ. A path of the switch S₁—the inductor L₁—the diode D_{b}—the switch S_{b} is formed by the switches S₁ and S_{b} that are turned on. Accordingly, the current I_{L1} that flows through the inductor linearly decreases to the current −Iₚₖ.

In the mode 3 period t₂ through t₃, a resonance path of the diode D₂—the inductor L₂—the panel capacitor Cₚ—the inductor L₁—the diode D₁ is formed since the switches S₁, S₂, S_{b}, and S_{b1} are turned off. Accordingly, resonance current caused by the inductor L₁+L₂ and the panel capacitor Cₚ flows. The panel both-end voltage Vₚ decreases to the voltage −Vₛ due to the current. The inductor currents I_{L1} and I_{L2} increase to 0.

In the mode 4 period t₃ through t₄, the switches S₃ and S₄ are turned on at the time t₃. Accordingly, the panel both-end voltage Vₚ is sustained to be at the voltage −Vₛ.

In the mode 5 period t₄ though t₅, the switches Sₐ and Sₐ₁ are turned on at the time t₄. A path of the switch Sₐ—the diode Dₐ—the inductor L₁—the switch S₃ is formed by the switches S₃ and Sₐ that are turned on. Accordingly, the current I_{L1} that flows through the inductor L₁ linearly increases to the current +Iₚₖ. Also, a path of the switch S₄—the inductor L₂—the diode Dₐ₁—the switch Sₐ₁ is formed by the switches S₄ and Sₐ₁ that are turned on. Accordingly, the current I_{L2} that flows through the inductor L₂ linearly increases to the current +Iₚₖ.

In the mode 6 period t₅ through t₆, a resonance path of the diode D₃—the inductor L₁—the panel capacitor Cₚ—the inductor L₂—the diode D₄ is formed since the switches S₃, S₄, Sₐ, and Sₐ₁ are turned off. Accordingly, resonance current caused by the inductor L₁+L₂ and the panel capacitor Cₚ flows. The panel both-end voltage Vₚ increases to the voltage +Vₛ and the inductor currents I_{L1} and I_{L2} decrease to 0 due to the current. When the switches S₁ and S₂ are turned on, the process returns to the mode 1 period and the cycles are repeated.

The driving method according to the fourth embodiment of the present invention having different driving waveforms will now be described with reference to FIG. 7.

As shown in FIG. 7, it is assumed that the switches S₃ and S₄ are turned on in a previous mode and that the panel both-end voltage Vₚ is the voltage −Vₛ. In the mode 1 period t₀ through t₁, when the switches Sₐ and Sₐ₁ are turned on, a path of the switch Sₐ—the diode Dₐ—the inductor L₁—the switch S₃ and the path of the switch S₄—the inductor L₂—the diode Dₐ₁—the switch Sₐ₁ are respectively formed. Accordingly, the inductor currents I_{L1} and I_{L2} linearly increase to current +Iₒ.

In the mode 2 period t₁ through t₂, the switches S₃ and S₄ are turned off while the inductor currents I_{L1} and I_{L2} increase. A resonance path of the switch Sₐ—the diode Dₐ—the inductor L₁—the panel capacitor Cₚ—the inductor L₂—the diode Dₐ₁—the switch Sₐ₁ is formed. Accordingly, the panel both-end voltage Vₚ increases from the voltage −Vₛ to the voltage +Vₛ. The inductor currents I_{L1} and I_{L2} increase from the current +Iₒ of the mode 1 to the current +Iₚₖ, due to the current caused by the resonance.

In the mode 3 period t₂ through t₃, when the panel both-end voltage Vₚ increases to the voltage +Vₛ, the switches S₁ and S₂ are turned on. Accordingly, the panel both-end voltage Vₚ is sustained to be at the voltage +Vₛ. The inductor currents I_{L1} and I_{L2} are recovered to the power through a path of the diode D₃—the inductor L₁—the body diode of the switch S₁ and a path of the body diode of the switch S₂—the inductor L₂—the diode D₄, and linearly decrease to 0. When the switches S₁ and S₂ are turned on, because the switches S₁ and S₂ are turned on in a state where the drain-source both-end voltage V_{ds} of each switch is the zero-voltage, it is possible to reduce the turn-on switching loss.

In the mode 4 period t₃ through t₄, the switches S_{b} and S_{b1} are turned on. Accordingly, the inductor currents I_{L1} and I_{L2} linearly decrease to current −Iₒ through a path of the switch S₁—the inductor L₁—the diode D_{b}—the switch S_{b} and a path of the switch S_{b1}—the diode D_{b1}—the inductor L₂—the switch S₂.

In the mode 5 period t₄ through t₅, the switches S₁ and S₂ are turned off while the inductor currents I_{L1} and I_{L2} decrease. A resonance path of the switch S_{b1}—the diode D_{b1}—the inductor L₂—the panel capacitor Cₚ—the inductor L₁—the diode D_{b}—the switch S_{b} is formed. Accordingly, the inductor currents I_{L1} and I_{L2} decrease from the current −Iₒ to the current −Iₚₖ. The panel both-end voltage Vₚ decreases from the voltage +Vₚ to the voltage −Vₚ due to the current.

In the mode 6 period t₅ through t₆, when the panel both-end voltage Vₚ decreases to the voltage −Vₛ, the switches S₃ and S₄ are turned on. Accordingly, the panel both-end voltage Vₚ is sustained to be at the voltage −Vₛ. The inductor currents I_{L1} and I_{L2} are recovered to the power through a path of the body diode of the switch S₃—the inductor L₁—the diode D₁ and a path of the diode D₂—the inductor L₂—the body diode of the switch S₄, and linearly increase to 0. Because the switches S₃ and S₄ are turned on in a state where the drain-source both-end voltage V_{ds} of each switch is the zero voltage, it is possible to reduce the turn-on switching loss. When the switches Sₐ and S₁ are turned on, the process returns to the mode 1 and the cycles are repeated.

As described in the third and fourth embodiments of the present invention, it is possible to increase the slope of a sustain-discharge voltage waveform without changing the current stress of a supplementary switch by previously boosting the current of the inductor. Accordingly, it is possible to prevent the panel from being discharged without special reasons when the sustain-discharge voltage increases and decreases.

While this invention has been particularly shown and described with reference to preferred embodiments thereof, it will be understood by those skilled in the art that various changes in form and details may be made therein without departing from the spirit and scope of the invention as defined by the appended claims.

As mentioned above, in the apparatus and method for driving the PDP according to embodiments of the present invention, because the sustain-discharge circuit can be operated by a switch, it is possible to simplify the structure of the driving circuit. Also, it is possible to reduce the switching loss because the operation switch that forms the sustain-discharge circuit can perform the zero voltage switching by applying a ¼ resonance current waveform instead of a half resonance current.

According to the apparatus and method for driving the PDP, it is possible to prevent the rush current without an additional external protecting circuit just after the light emission starts.

In addition, it is possible to improve power efficiency by reducing switch conductance loss caused by circulating current shown in conventional sustain-discharge.

Also, it is possible to increase the slope of a sustain-discharge voltage waveform without changing the current stress of a supplementary switch by previously boosting the current of the inductor. Accordingly, it is possible to prevent the panel from being discharged without special reasons when the sustain-discharge voltage increases and decreases. It is also possible to prevent the generation of the rush current for charging the energy recovery capacitor when the sustain-discharge starts, so it is possible to improve the reliability and quality of products.

What is claimed is:

1. An apparatus for driving a plasma display panel including a plurality of address electrodes, a plurality of scan electrodes and sustain electrodes arranged in a zig-zag pattern so as to make pairs with each other, and a panel capacitor formed by the scan electrodes and the sustain electrodes, comprising:
a sustain-discharge unit comprising first and second switches that are serially connected to each other between a power source to which a sustain-discharge voltage is applied and a ground, and whose contact point is connected to a first end of the panel capacitor, and third and fourth switches that are serially connected to each other between the power source and the ground, and whose contact point is connected to a second end of the panel capacitor;
a first charge and discharge unit comprising a first inductor with a first end coupled to the first end of the panel capacitor, the first charge and discharge unit for increasing the voltage of the panel capacitor to the first sustain-discharge voltage using resonance of the first inductor and the panel capacitor; and
a second charge and discharge unit comprising a second inductor with a first end coupled to the second end of the panel capacitor, the second charge and discharge unit for decreasing the voltage of the panel capacitor to the second sustain-discharge voltage using a resonance of the second inductor and the panel capacitor,
wherein the sustain-discharge unit drives the first switch during the resonance of the first inductor to thus sustain the first sustain-discharge voltage, and drives the third switch during the resonance of the second inductor to thus sustain the second sustain-discharge voltage.

2. The apparatus of claim 1, wherein the first charge and discharge unit further comprises:
a fifth switch connected between the power source and a second end of the first inductor and operating so that the voltage of the panel capacitor increases to the first sustain-discharge voltage; and
a first diode connected between the second end of the first inductor and the ground, the first diode for providing a path through which the current of the first inductor is recovered to the power source through a body diode of the first switch while the voltage of the panel capacitor is sustained to be at the first sustain-discharge voltage.

3. The apparatus of claim 2, wherein the first charge and discharge unit further comprises:
a second diode connected between the first end of the first inductor and the first end of the panel capacitor, the second diode for preventing the flow of current received from the panel capacitor; and
a third diode connected between the second diode and the second switch, the third diode for forming a resonance path caused by the second inductor.

4. The apparatus of claim 1, wherein the second charge and discharge unit further comprises:
a fifth switch connected between the power source and a second end of the second inductor and operating so that voltage of the panel capacitor decreases to the second sustain-discharge voltage; and
a first diode connected between the second end of the second inductor and the ground, the first diode for providing a path through which current of the second inductor is recovered to the power source through a body diode of the third switch while voltage of the panel capacitor is sustained to be at the second sustain-discharge voltage.

5. The apparatus of claim 4, further comprising:
a second diode connected between the first end of the second inductor and the second end of the panel capacitor, the second diode for preventing the flow of current received from the panel capacitor; and
a third diode connected between the second diode and the fourth switch, the third diode for forming a resonance path caused by the first inductor.

6. The apparatus of claim 1, wherein the first charge and discharge unit further comprises:
fifth and sixth switches, that are serially connected to each other between the power source and the ground, and whose contact point is connected to a second end of the first inductor, which operate so that voltage of the panel capacitor increases to the first sustain-discharge voltage and decreases to the second sustain-discharge voltage;
a first diode connected between the ground and the second end of the first inductor, the first diode for providing a current path through which current of the first inductor is recovered to the power source through a body diode of the first switch while voltage of the panel capacitor is sustained to be at the first sustain-discharge voltage; and
a second diode connected between the second end of the first inductor and the power source, the second diode for providing a current path through which current of the first inductor is recovered to the power source through a body diode of the second switch while the voltage of the panel capacitor is sustained to be at the second sustain-discharge voltage.

7. The apparatus of claim 6, wherein the first charge and discharge unit further comprises:
a third diode connected between the fifth switch and the second end of the first inductor, the third diode for providing a current flow path from the power source to the panel capacitor; and
a fourth diode connected between the second end of the first inductor and the sixth switch, the fourth diode for providing a current flow path from the panel capacitor to the ground.

8. The apparatus of claim 1, wherein the second charge and discharge unit further comprises:
fifth and sixth switches that are serially connected to each other between the power source and the ground, and whose contact point is connected to a second end of the second inductor, which operate so that voltage of the panel capacitor decreases to the second sustain-discharge voltage and increases to the first sustain-discharge voltage;
a first diode connected between the ground and the second end of the second inductor, the first diode for providing a current path through which current of the second inductor is recovered to the power source through a body diode of the third switch while voltage of the panel capacitor is sustained to be at the second sustain-discharge voltage; and
a second diode connected between the second end of the second inductor and the power source, the second diode for providing a current path through which current of the second inductor is recovered to the power source through a body diode of the fourth switch while voltage of the panel capacitor is sustained to be at the first sustain-discharge voltage.

9. The apparatus of claim 8, wherein the second charge and discharge unit further comprises:
a third diode connected between the fifth switch and the second end of the second inductor, the third diode for providing a current flow path from the power source to the panel capacitor; and
a fourth diode connected between the second end of the second inductor and the sixth switch, the fourth diode for providing a current flow path from the panel capacitor to the ground.

10. An apparatus for driving a plasma display panel including a plurality of address electrodes, a plurality of scan electrodes and sustain electrodes arranged in a zig-zag pattern so as to make pairs with each other, and a panel capacitor formed by the scan electrodes and the sustain electrodes, comprising:
first and second switches that are serially connected to each other between a power source to which a sustain-discharge voltage is applied and a ground and whose contact point is connected to a first end of the panel capacitor;
third and fourth switches that are serially connected to each other between the power source and the ground, and whose contact point is connected to a second end of the panel capacitor;
a first inductor with a first end coupled to a first end of the panel capacitor, and a second inductor with a first end coupled to a second end of the panel capacitor;
fifth and sixth switches respectively connected between the power source and a second end of the first inductor and between the power source and a second end of the second inductor; and
first and second diodes respectively connected between the second end of the first inductor and the ground and between the second end of the second inductor and the ground.

11. The apparatus of claim 10, further comprising:
third and fourth diodes respectively connected between the first end of the first inductor and the first end of the panel capacitor and between the first end of the second inductor and the second end of the panel capacitor in a forward direction; and
fifth and sixth diodes respectively connected between the third diode and the second switch and between the fourth diode and the fourth switch in a forward direction.

12. An apparatus for driving a plasma display panel including a plurality of address electrodes, a plurality of scan electrodes and sustain electrodes arranged in a zig-zag pattern so as to make pairs with each other, and a panel capacitor formed by the scan electrodes and the sustain electrodes, comprising:
first and second switches that are serially connected to each other between a power source to which a sustain-discharge voltage is applied and a ground, and whose contact point is connected to a first end of the panel capacitor;
third and fourth switches, that are serially connected to each other between the power source and the ground, and whose contact point is connected to a second end of the panel capacitor;
a first inductor whose one end is coupled to one end of the panel capacitor, and a second inductor whose one end is coupled to the other end of the panel capacitor;
fifth and sixth switches that are serially connected to each other between the power source and the ground, and whose contact point is connected to a second end of the first inductor;
seventh and eighth switches that are serially coupled to each other between the power source and the ground, and whose contact point is connected to a second end of the second inductor;
first and second diodes that are serially connected to each other between the power source and the ground in a backward direction, and whose contact point is connected to the second end of the first inductor; and
third and fourth diodes that are serially connected to each other between the power source and the ground in a backward direction, and whose contact point is connected to the second end of the second inductor.

13. The apparatus of claim 12, further comprising:
fifth and sixth diodes respectively connected between the fifth switch and the second end of the first inductor and between the second end of the first inductor and the sixth switch in a forward direction; and
seventh and eighth diodes respectively connected between the seventh switch and the second end of the second inductor and between the second end of the second inductor and the eighth switch in a forward direction.

14. A method for driving a plasma display panel including a plurality of address electrodes, a plurality of scan electrodes and sustain electrodes arranged in a zig-zag pattern so as to make pairs with each other, a panel capacitor formed by the scan electrodes and the sustain electrodes, first and second switches that are serially connected to each other between a power source for supplying a sustain-discharge voltage and a ground and whose contact point is connected to a first end of the panel capacitor, third and fourth switches that are serially connected to each other between the power source and the ground and whose contact point is connected to a second end of the panel capacitor, and first and second inductors connected to the first end and the second end of the panel capacitor, the method comprising:
(a) increasing voltage of the panel capacitor to a first sustain-discharge voltage using a resonance generated by the panel capacitor and the first inductor due to the driving of the fourth switch and a fifth switch connected between the power source and the first inductor;
(b) driving the first and fourth switches during the resonance, to thus sustain voltage of the panel capacitor to be at the first sustain-discharge voltage;
(c) decreasing voltage of the panel capacitor to a second sustain-discharge voltage using a resonance generated by the panel capacitor and the second inductor due to the driving of the second switch and a sixth switch connected between the power source and the second inductor; and
(d) driving the second and third switches during the resonance, to thus sustain voltage of the panel capacitor to be at the second sustain-discharge voltage.

15. The method of claim 14, wherein the step (b) further comprises the step of turning off the fifth switch to thus recover current of the first inductor to the power source through a diode connected between the first inductor and the ground, the first inductor, and a body diode of the first switch.

16. The method of claim 14, wherein the step (d) further comprises the step of turning off the sixth switch to thus recover current of the second inductor to the power source through a diode connected between the second inductor and the ground, the second inductor, and a body diode of the third switch.

17. A method for driving a plasma display panel including a plurality of address electrodes, a plurality of scan electrodes and sustain electrodes arranged in a zig-zag pattern so as to make pairs with each other, a panel capacitor formed by the scan electrodes and the sustain electrodes, first and second switches that are serially connected to each other between a power source for supplying a sustain-discharge voltage and a ground, and whose contact point is connected to a first end of the panel capacitor, third and fourth switches that are serially connected to each other between the power source and the ground, and whose contact point is connected to a second end of the panel capacitor, and first and second inductors connected to the first end and the second end of the panel capacitor, the method comprising:
(a) increasing voltage of the panel capacitor to a first sustain-discharge voltage using a resonance generated by the panel capacitor and the first and second inductors due to the driving of a fifth switch connected between the power source and the first inductor and a sixth switch connected between the second inductor and the ground;
(b) turning off the fifth and sixth switches during the resonance and driving the first and fourth switches to thus sustain voltage of the panel capacitor to be at the first sustain-discharge voltage;
(c) decreasing voltage of the panel capacitor to a second sustain-discharge voltage using a resonance generated by the panel capacitor and the first and second inductors due to the driving of a seventh switch connected between the power and the second inductor and an eighth switch connected between the first inductor and the ground; and
(d) turning off the seventh and eighth switches during the resonance and driving the second and third switches to thus sustain voltage of the panel capacitor to be at the second sustain-discharge voltage.

18. The method of claim 17, wherein the step (b) further comprises the step of recovering current of the first inductor to the power source through a first diode connected between the ground and the first inductor, the first inductor, and a body diode of the first switch, and recovering current of the second inductor through the body diode of the fourth switch, the second inductor, and a second diode connected between the second inductor and the power source.

19. The method of claim 17, wherein the step (d) further comprises the step of recovering current of the first inductor through a body diode of the second switch, the first inductor, and a first diode connected between the first inductor and the power source and recovering the second inductor through a second diode connected between the ground and the second inductor, the second inductor, and a body diode of the third switch.

20. A method for driving a plasma display panel including a plurality of address electrodes, a plurality of scan electrodes and sustain electrodes arranged in a zig-zag pattern so as to make pairs with each other, a panel capacitor formed by the scan electrodes and the sustain electrodes, first and second switches that are serially connected to each other between a power source for supplying a sustain-discharge voltage and a ground and whose contact point is connected to a first end of the panel capacitor, third and fourth switches that are serially connected to each other between the power source and the ground and whose contact point is connected to a second end of the panel capacitor, and first and second inductors connected to the first end and the second end of the panel capacitor, the method comprising:
(a) driving the first and fourth switches to thus sustain voltage of the panel capacitor to be at a first sustain-discharge voltage;
(b) additionally driving fifth and sixth switches respectively connected between the ground and the first inductor and between the second inductor and the power source to thus inject current into the first and second inductors in a state where voltage of the panel capacitor is sustained to be at the first sustain-discharge voltage;
(c) turning off the first, fourth, fifth, and sixth switches to thus decrease voltage of the panel capacitor to a second sustain-discharge voltage using a resonance generated by the first and second inductors and the panel capacitor;
(d) driving the second and third switches to thus sustain voltage of the panel capacitor to be at the second sustain-discharge voltage;
(e) additionally driving seventh and eighth switches respectively connected between the power source and the first inductor and between the second inductor and the ground to thus inject current into the first and second inductors in a state where voltage of the panel capacitor is sustained to be at the second sustain-discharge voltage; and
(f) turning off the second, third, seventh, and eighth switches to thus increase voltage of the panel capacitor to a first sustain-discharge voltage using a resonance generated by the first and second inductors and the panel capacitor.

21. A method for driving a plasma display panel including a plurality of address electrodes, a plurality of scan electrodes and sustain electrodes arranged in a zig-zag pattern so as to make pairs with each other, a panel capacitor formed by the scan electrodes and the sustain electrodes, first and second switches that are serially connected to each other between a power source for supplying a sustain-discharge voltage and a ground and whose contact point is connected to a first end of the panel capacitor, third and fourth switches that are serially connected to each other between the power source and the ground and whose contact point is connected to a second end of the panel capacitor, and first and second inductors connected to the first end and the second end of the panel capacitor, the method comprising:
(a) driving fifth and sixth switches respectively connected between the power source and the first inductor and between the second inductor and the ground to thus inject current into the first and second inductors in a state where voltage of the panel capacitor is sustained to be at a first sustain-discharge voltage by the driven second and third switches;
(b) turning off the second and third switches to thus increase voltage of the panel capacitor to a second sustain-discharge voltage using a resonance generated by the first and second inductors and the panel capacitor;
(c) turning off the fifth and sixth switches and driving the first and fourth switches to thus sustain voltage of the panel capacitor to be at the second sustain-discharge voltage;
(d) additionally driving seventh and eighth switches respectively connected between the first inductor and the ground and between the power source and the second inductor to thus inject current into the first and second inductors in a state where voltage of the panel capacitor is sustained to be at the second sustain-discharge voltage;
(e) turning off the first and fourth switches to thus decrease the panel capacitor to the first sustain-discharge voltage using a resonance generated by the first and second inductors and the panel capacitor; and
(f) turning off the seventh and eighth switches and driving the second and third switches to thus sustain voltage of the panel capacitor to be at the first sustain-discharge voltage.

22. The method of claim 21, wherein the step (c) further comprises the step of recovering current of the first inductor to the power source through a first diode connected between the ground and the first inductor, the first inductor, and a body diode of the first switch, and recovering current of the second inductor through a body diode of the fourth switch, the second inductor, and a second diode connected between the second inductor and the power source.

23. The method of claim 21, wherein the step (f) further comprises the step of recovering current of the first inductor to the power source through a body diode of the second switch, the first inductor, and a first diode connected between the power source and the first inductor, and recovering current of the second inductor to the power source through a second diode connected between the ground and the second inductor, the second inductor, and a body diode of the third switch.
